(19) United States
(12) Patent Application Publication
(10) Pub. No.: US 2018/0204288 A1
(43) Pub. Date: Jul. 19, 2018

(54) Cash Flow Management System

(71) Applicant: Govindraj Muthyalu, Bangalore (IN)

(72) Inventor: Govindraj Muthyalu, Bangalore (IN)

(21) Appl. No.: 15/743,285

(22) PCT Filed: Jun. 20, 2016
(86) PCT No.: PCT/IB2016/053650

§ 371 Date: Jan. 10, 2018

(30) Foreign Application Priority Data
Jul. 10, 2015 (IN) 3546/CHE/2015

(51) Int. Cl. G06Q 40/00; G06Q 40/08

(52) U.S. Cl. CPC G06Q 40/12; G06F 17/30575; G06Q 40/08

(57) ABSTRACT

The present invention provides a cash flow management system. The system (100) comprising at least one memory at user's location and one or more processors (201) at server locations. The processor (100) comprises of three modules. A display module (202) is configured to display a unified platform to the user (s), which includes financial status of one or more customers and vendors with respect to invoices and bills. A recommendation module is (203) configured to recommend the names of customers and vendors to the user (s) from displayed list, which assists the user (s) in reminding pending financial status of customers and vendors, which needs to be made within predetermined date and time. A cash-flow module (204) is configured to provide detailed projected cash flow statement to the user (s), which includes inflows from budgeted sales and purchases, receivables, payables, overhead expenses of the company during specific period of time.

### CROSS REFERENCE TO RELATED APPLICATION

The present application is a U.S. national stage application (under 35 USC §§ 371) of PCT international application PCT/IB2016/053650 having an international filing date 20 Jun. 2016, which claims priority from Indian application No. 3546/CHE/2015 filed with Indian Patent Office, Chennai on 10 Jul. 2015.

### TECHNICAL FIELD OF THE INVENTION

The present invention relates to a Cash Flow Management System, which assists user (s) in managing their Accounts Receivables, Accounts Payables, Post Dated Cheques, and Cash Flows.—

### BACKGROUND OF THE INVENTION

Over the past several years, the e-commerce, or e-business applications have been playing a major role in assisting business, by providing various solutions to business related activities, especially in the field of accounting and finance. The available ERP and financial accounting application provide balance sheet, profit and loss account, historical cash flow statement, accounts receivable and payable statements and few other finance related statements. In the recent year, the CRM application have become available that allow businesses to manage their relationship with customers. Furthermore, cloud solutions have become available, that allow individuals to perform transactions over the internet through secure website. This type of service enables customers to do their transaction processing from anywhere where the internet access is available. Thus cloud applications are becoming a common place. However these applications do not help businesses to generate projected cash flow statements/cash forecast, manage and follow-up receivables and payables, maintain history of communication with customers and vendors, manage post dated cheques, notify credit insurers etc. Recent developments in the e-business and cloud applications have led to the development of cash flow management systems. The cash flow management system assist businesses in managing all aspects of cash flows which include managing accounts Receivables, accounts payables, Post Dated Cheques (PDCs), cash inflows and cash outflows.

Various types of conventional Cash Flow Management Systems are known in the prior art, wherein most of them are used to figure out mainly the accounts receivables. For example, U.S. Pat. No. 8,401,892 B2 describes System and Method of analysing accounts receivable and sales outstanding. The claimed system and method is used to perform an analysis of the accounts receivable of a business. Each component of the accounts receivable is reviewed individually and all factors related to that particular component are accounted for. A data tool is then implemented to analyse the data and to recognize the areas of all of the components that are susceptible to improvement. A strategy is then developed to maximize the efficiency of the accounts receivable. However, the use of claimed system and method does not facilitate the generation of detailed projected cash flow statements and management of receivables, payables, post dated cheques, credit insurance notifications, and communication with customers and vendors.

For example, U.S. Patent document 2014/0222669 A1 describes Integrated Electronic Cash Flow Management System and Method. The claimed cash flow management system is provided within a host system for facilitating cash flow management for businesses. The cash flow management system includes an electronic billing and invoicing computing system enabling generation and transmission of electronic bills based on business invoices and for displaying the generated bills for payment and an integrated receivables and reconciliation system receiving notification of received payments and for matching received payments with the generated invoices. The system additionally includes a communication interface for allowing the cash flow management system to communicate with multiple financial management systems accessible to the host enterprise, the systems including at least an accounting system, the integrated receivables management system receiving information from the financial management systems within the host system to facilitate management of cash flow for the businesses using the cash flow management system for electronic billing. However, the use of claimed system and method provides electronic billing for the receivables and matching received payments with the generated invoices, but does not facilitate the generation of detailed Projected Cash Flow Statements and management of receivables, payables, post-dated cheques, credit insurance notifications, and communication with customers and vendors.

For example, U.S. Pat. No. 8,712,887 B2 describes electronic multiparty accounts receivable and accounts payable system. The claimed system concerns a multipolar accounts receivables and accounts payable system that allows business trading partners to use a single, shared system for both accounts receivable and accounts payable management. The system allows participants to use the substantial amount of financial and cash flow information captured by the system to borrow more efficiently by permitting lenders to view this information. Furthermore, the system provides a confirmation process to convert existing debt obligations into a new, independent payment obligation due on a date certain and free of any defences to the underlying contract. The confirmed debt obligations provide a better source of working capital for the participants, or can be converted into electronic promissory notes. The system provides an electronic exchange for electronic promissory notes, allowing participants to raise working capital in various ways, for example, by selling them. However the claimed system mainly helps participants to borrow more efficiently by permitting vendors to view the accounts receivable and accounts payable information but does not facilitate the generation of detailed projected cash flow statements and management of receivables, payables, post dated cheques, credit insurance notifications, and communication with customers and vendors.

For example, U.S. Patent document 2011/0246314 A1 describes cash management system and method. The claimed system relates to a new system and method for conducting business that provides a fully integrated cash management system for easily accessible, real-time cash flow figures for all vaults, sub vaults, banks, mini banks, point-of-sale (POS) stations, ticket redemption kiosks and automated teller machines (ATM) for casinos, gaming centres, and casino resorts. The invention may be utilized in multiple sites and utilized for resorts, retail in general, banks, stadiums, theme parks and so forth. However the claimed system does not facilitate the generation of detailed projected cash flow statements and management of receivables, payables, post-dated cheques, credit insurance notifications, and communication with customers and vendors.

Typically, in almost all businesses, irrespective of the ERP or the accounting application used, the accountants export the receivables data to a spreadsheet such as Microsoft Excel from their ERP or accounting applications to follow-up receivables. They will go through the receivables data invoice by invoice and start following up one by one. They will add a remarks column at the end and note the details of communications with the customers there. If the customer says that he or she will pay a particular invoice on say 15^{th} of a month, the accountants will make a note of that in the remarks column and again make a note in their dairy or somewhere that they need to follow-up again on 15^{th} to ensure that the payment is received. In the cash flow statement the amount of this particular invoice has to be shown as inflow on 15^{th} of the month. This whole exercise is manual, takes lot of time and is prone to mistakes. This exercise is repeated every week, fortnight, or month depending on the volume of transaction since some customers would have paid their invoices and invoices of few other customers would have become overdue needing follow-up. Later on, the projected cash flow statement or cash forecast is prepared manually in spreadsheet taking into account a) the opening cash/bank balance, b) the inflow of cash from sales invoices based on the dates promised by customers during follow-ups, c) outflow of cash towards payment of vendor bills, and d) outflow of cash towards estimated expenses/overheads. This statement is prepared day-wise, or consolidated week-wise or month-wise. Again this whole exercise is manual, takes lot of time, and needs weekly updation.

Hence, there is need for a cash flow management system, which assists businesses in managing not only accounts receivables but also accounts payables, post-dated cheques, credit insurance notifications and all aspects of cash inflows and outflows including communication with customers and vendors.

### SUMMARY OF THE INVENTION

The present invention overcomes the drawbacks in the prior art and provides a cash flow management system, which assists businesses in managing not only accounts receivables but also accounts payables, post-dated cheques, credit insurance notifications, and all aspects of cash inflows and outflows including communication with customers and vendors.

In most preferred embodiment, the system comprises of at least one computer memory at user (s) location for storage of user's business data. The business data includes financial details of the user (s) with respect to their vendors and customers. At least one processor at server location for accessing the stored financial details from the user's computer. The processor further comprises of a display module, a recommendation module and a cash-flow module. The displaying module configured to display a unified platform to the user (s), wherein the unified platform displays financial status of one or more of customers and vendors with respect to the invoices and bills. The recommendation module configured to recommend the names of customers and vendors to the user (s) from the displayed list, wherein the recommended names from the displayed list assist the user (s) in reminding pending financial status of the customers and vendors, which needs to be made within the predetermined date and time. The cash-flow module is configured to provide detailed financial report to the user (s), wherein the detailed financial report includes projected financial receivables payables, overheads of the company during a specific period of time in the future.

In a preferred embodiment of the invention, the business data in the server location is automatically updated based on the modifications in the user's computer by the user (s).

In a preferred embodiment of the invention, the recommendation module further recommends the user (s) about the invoices of the customers and bills of vendors with one or more colours, wherein the indicated colours in the displayed list assist the user (s) in reminding pending financial status of the customers and vendors within the predetermined date.

In a another embodiment of the invention, the system further comprises of a representation module configured to plot a graph, wherein the graph assists the user (s) in understanding the financial flow details in the business with respect to the date and time.

In a another embodiment of the invention, the system further comprises of a master module which is configured to display and store the names of customers and vendors, wherein the displayed list helps the user (s) in accessing individual customer and vendor information such as name, email, contact number, financial status, etc.

In a preferred embodiment of the invention, the system is further configured to alert the user (s) about pending financial status of the customers and vendors with respect to the invoices and bills at defined regular intervals of time even after the predetermined date and time.

In a preferred embodiment of the invention, the system is further configured to set up various configurations such as user roles, user profiles, insurance company policies, form permissions, email templates, etc.

In another embodiment of the invention, the system is further configured to keep track and update the credit insurance policy purchased by the user (s) for the selected customers, wherein the updated credit insurance policy alerts the user (s) and insurance agency in providing pending financial details of the selected customers and vendors with respect to the invoice numbers, due date, stop date and alert date.

In a another embodiment of the invention, the system is further reminds the user (s) to assist the customers in renewing the expiry of the letter of guarantee provided by the banks on behalf of customers, wherein the letter of guarantee helps the user (s) to provide services to the customers and vendors.

In a preferred embodiment of the invention, the system is further configured to alert the user (s) about the PDC (Post Dated Cheques) and LC (Letter of Credits) that are received and issued from/to the customers and vendors.

In a preferred embodiment of the invention, the system further displays the only pending invoices and bills of the customers and vendors to the user (s), wherein the display of pending invoices and bills includes contact details, mode of payment with respect to predetermined date and time and financial details of the payables and receivables.

In a preferred embodiment of the invention, the system further automatically sends email notification to the customers and vendors regarding pending invoices and bills, wherein the email notification includes the financial details of the receivables and payables of the company (s).

In a preferred embodiment of the invention, the system allows the users to manually select the pending invoices and bills of the customers and vendors to send email, wherein the email includes attachment of the financial details of receivables and payables of the company.

In a preferred embodiment of the invention, the system allows the user to see the net amount receivable or payable from a customer or a vendor, in case the same party is both a customer and a vendor.

In a preferred embodiment of the invention, the system allows the user to check the credit rating of the customers as per the reputed credit rating agencies.

In a preferred embodiment of the invention, the system provides access to various users (s) based on the access rights given to them, wherein the users may be given access to information related to few customers and vendors respectively during login.

In a preferred embodiment of the invention, the system further allows users to generate projected cash flow statements on a daily or weekly or monthly basis, wherein the statement includes a particular bank account, a project, or a division of the company.

In a preferred embodiment of the invention, the system suggests users to borrow funds to fill the gap and recommends the names of financial consultants who may arrange funding, during the shortfall in the projected cash balance.

The invented system eliminates the use of accounting application where the user (s) need to enter complete receivables, payables and cash flows in excel format manually and also eliminates the system which helps the user (s) to manage only financial receivables. The invented system provides a cash flow management application which assists the user (s) in reminding all aspects of financial status which includes receivables management, payables management, and cash flow projection management. In the invented system, the user (s) may export relevant financial details of the customers and vendors to excel and pdf format automatically.

The system is easy to use and simple and is more suitable for applications in trading, services, distribution, manufacturing, real estate, contracting and many other companies. It is to be understood that both the foregoing general description and the following details description are exemplary and explanatory and are intended to provide further explanation of the invention as claimed.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates a system to provide cash flow management to the user (s), according to one embodiment of the invention.

FIG. 2 illustrates a block diagram of a system to provide cash flow management to the user (s), according to one embodiment of the invention.

### DETAILED DESCRIPTION OF THE INVENTION

Reference will now be made in detail to the description of the present subject matter, one or more examples of which are shown in figures. Each embodiment is provided to explain the subject matter and not a limitation. These embodiments are described in sufficient detail to enable a person skilled in the art to practice the invention, and it is to be understood that other embodiments may be utilized and that logical, physical, and other changes may be made within the scope of the embodiments. The following detailed description is, therefore, not be taken as limiting the scope of the invention, but instead the invention is to be defined by the appended claims.

The present invention provides a cash flow management system, which assists user (s) in cash flow management as well as keeps track of financial status of the customers and vendors. The system comprises of at least one memory at user's location and one or more processors at server locations. The processor comprises of three modules. The system includes a displaying module configured to display a unified platform to the user (s), which includes financial status of one or more of customers and vendors with respect to the invoices and bills. A recommendation module configured to recommend the names of customers and vendors to the user (s) from the displayed list. The displayed list assists the user (s) in reminding pending financial status of customers and vendors, which needs to be made within the predetermined date and time. A cash-flow module is configured to provide detailed financial report to the user (s), which includes projected financial receivables, payables, and overheads of the user (s) towards the customers and vendors during a specific period of time in the future.

The invented system eliminates the need to enter complete receivables, payables and cash flows in excel format manually and also eliminates the system which helps the user (s) to manage only financial receivables. The invented system provides a cash flow management application which assists the user (s) in reminding the financial status which includes receivables management, payables management, overhead expense management and cash flow projection management. In the invented system, the user (s) may export relevant financial details to excel format automatically

The system is easy to use and simple and is more suitable for applications in trading, services, distribution, manufacturing, real estate, contracting and many other companies.

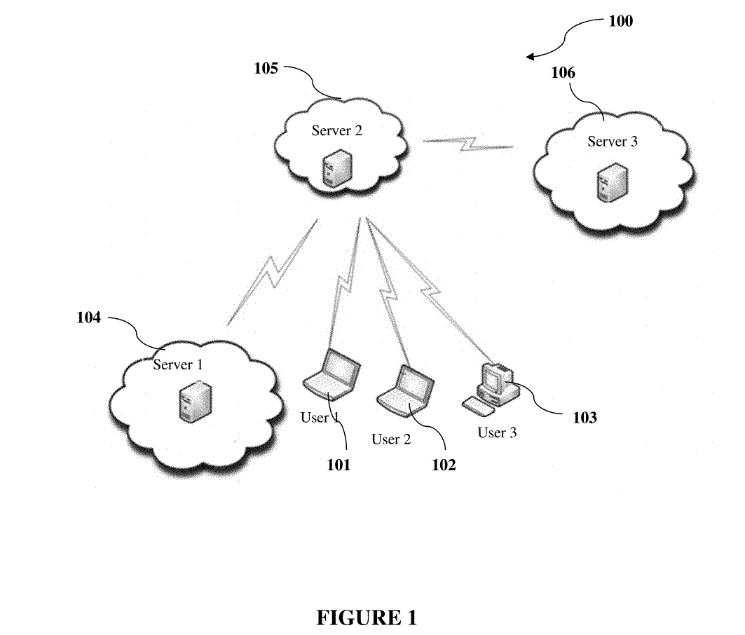

FIG. 1 illustrates a system to provide and assist in cash flow management to the user (s), according to one embodiment of the invention. The system (100) comprises of three computer memories (101, 102, and 103) and three servers. The three computer memories (101, 102, and 103) are memory 1 (101), memory 2 (102) and memory 3 (103). The three servers (104, 105 and 106) are server 1 (104), server 2 (105) and server 3 (106). The three memories (101, 102 and 103) are stored at user's location. The server 1 (104) may be stored at user's location. The server 2 (105) and server 3 (106) will be located at a third party data center located anywhere in the world.

The server 1 (104) at user (s) location stores user's business data. The business data includes financial details of the user (s) with respect to their customers and vendors' bank accounts, overhead expenses etc. The financial details include complete information of the receivables and payables made by the user (s) towards the vendors and customers. A “Desktop Application (DA)” installed at server 1 (104) fetches the stored financials details from the server 1 (104) and sends the data via public or private IP to server 2 (105) The server 2 (105) processes the accessed financial details of the user (s), which includes complete information of the receivables and payables, overhead expenses, bank account details etc, of the user (s) towards the vendors and customers. The server 3 (106) provides back up storage of financial details for the server 2 (105) and server 1 (104), in case of any disaster in stored financial details.

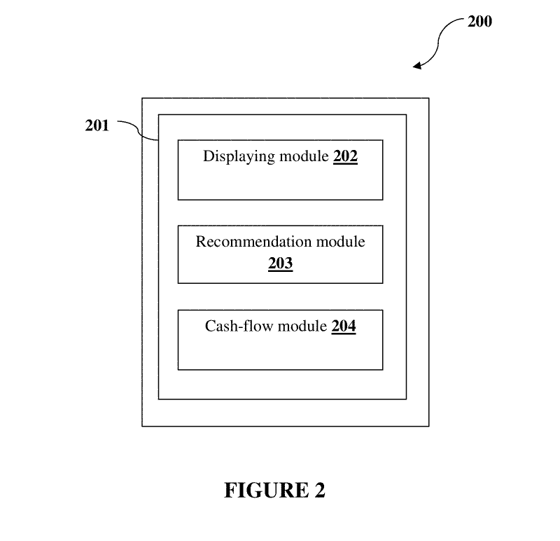

FIG. 2 illustrates a block diagram of a system to provide and assist in cash flow management to the user (s), according to one embodiment of the invention. The system (200) comprises of at least one processor (201) which is used inside the three servers. The processor (201) at server location accesses the stored financial details from the server 1 (104). The processor (201) further comprises of a display module (202), recommendation module (203), and a cash-flow module (204). The display module (202) is configured to display a unified platform to the user (s). The unified platform displays financial status of one or more of customers and vendors with respect to receivables s and payables of the company.

Display Module (202) Configured to Display with Respect to Receivables:

The display module (202) displays financial status of one or more customers to user (s). The display module (202) displays the financial status of customers to the user (s) in three dates, in the order of listing. The three dates are promised date, payment cycle date and due-date for the respective invoice. The promised date indicates the date on which the customer has promised to make the payment to the user (s). The payment cycle date indicates the date which may differ from customer to customer. A customer may have one or more payment cycle date(s) a month. The due date indicates the date when the invoice becomes due. The display module (202) further displays pending follow-ups to the user (s) i.e. the display module (202) displays the names of customers along with the contact person and invoice number. This helps the user (s) to follow up for collecting the receivables from the particular customer.

Recommendation (203) Module Configured to Recommend the Names of Customers to the User (s) from the Displayed List:

The recommendation module (203) is configured to recommend and remind the names of customers to the user (s). The recommended and reminded customer names are expected to make payment within the next three to seven days. The list of customers is arranged in the same order of priority as that of the “cash inflow dates”. The recommendation module reminds the user (s) about the total amount expected to be received per day, and also the total amount expected to be received within the next three to seven days from each of the customers listed in this section, is displayed.

In the preferred embodiment, the recommendation module (203) lists names of customers whose invoices are overdue. Here, user (s) may view that some of the over-due records that are listed in one or more colors. This is to indicate that these receivables are not received even after the “promised date”. The recommendation module lists the individual invoice details. Hence, user (s) may view number of records of the same customer. The records includes the invoice number, invoice date, due-date, promised date, home currency amount (this is the home currency amount of the accounting system), foreign currency amount (this is the foreign currency equivalent of the home currency amount) and overdue days.

In further embodiment, the recommendation module (203) further recommends and reminds the list customer names and details of their invoices that will be overdue in the next seven days. The default is seven days. Here, the user (s) may change the default number of days in the settings.

The System Configured to Alert the User (s) about Receivables:

In preferred embodiment, the system is configured to provide detailed financial report to the user (s). The detailed financial report includes financial receivables of the company from the customers during a specific period of time. There may be times when user (s) customer gives the Post Dated Cheques (PDC) or issues Letter of Credits (LC) in business transactions. In the preferred embodiment, the system lists the details such as the name of the customer who has given user (s) a PDC or LC against the invoice number, PDC/LC number, due date of the invoice, PDC/LC date, invoice amount, PDC/LC amount, adjusted amount (this is the amount that will be adjusted from the PDC/LC towards the invoice) and balance amount (this is the invoice amount left over after adjusting PDC/LC against the invoice).

Display Module (202) Configured to Display with Respect to Payables:

The display module (202) displays financial status of one or more vendors to user (s). The display module displays the names of vendors whose payments are expected to be released in next seven days. Here, the user (s) will know details such as the total amount of payment to be released on a single day for the next seven days, total amount of payment to be made to a particular vendor for the week, and the total amount of payment to be made for the week for all the vendors together. The display module (202) is further configured to list all the vendor bills which are overdue for a particular period of time. The list includes name of vendor, bill number, bill date, due date, promised date (this is the date when user had promised to make payment), home currency amount (this is the amount of currency of your accounting application), foreign currency amount (this is the amount in foreign currency), and overdue days (this is the number of days by which the payment is overdue after the due date by the user (s)).

Recommendation Module (203) Configured to Recommend the Names of Vendors to the User (s) from the Displayed List:

The recommendation module (203) is configured to recommend and remind the names of vendors to the user (s). The recommendation module lists the vendor names and details of bills that will be overdue in the next seven days. The default is seven days. Here, the user (s) may change the default number of days in the settings.

The System (100) Configured to Alert the User (s) about Payables:

The system (100) is configured to provide detailed financial report to the user (s). The detailed financial report includes financial payables made by the user (s) towards the vendors during a specific period of time. The system lists the names of vendors and their bills against which user (s) have issued PDCs/LCs, PDC/LC number, PDC/LC date, bill amount, PDC/LC amount, adjusted amount (this is the amount that is adjusted from the PDC/LC amount towards the bill amount), and the balance amount (this is the bill amount that is remaining after adjusting the PDC/LC). In the preferred embodiment, the cash-flow module further lists the recurring estimated overheads of the user (s), as set up in the cash flow dashboard. Here, user (s) may view the amount, frequency, payment date, start date, and end date.

In further embodiment, the system (100) configured to calculate the future expenditures such as capital expenses or term loan. Here, user (s) may view the amount, frequency, and payment date, start date, and end date.

Recommendation Module with Respect to Receivables Through Communication:

The recommendation module (203) is configured to display and reminds the user (s) about the invoices details pertaining to particular customer. The invoice details include different overdue dates i.e. invoices overdue by 1-30 days after the credit period, 31-60 days overdue after the credit period, 61-90 days overdue after the credit period, and also, 91+ days overdue after the credit period, are listed. The system lists the unallocated invoices, PDC, LC, and on hold invoices that are doubtful to be received from the selected customer. Here, the user (s) may also know the net balance of all the receivables of the particular customer. In the preferred embodiment, the system further recommends the user (s) about the lists of all the outstanding invoices pertaining to the selected customer. The system recommends the user (s) based on Credit Limit (limit that user (s) have agreed to extend to with the customer), LG Amount (Letter of Guarantee issued for the amount by the bank), payment terms (terms of payment agreed to with the customer), credit insurance (credit limit approved by the insurance company) and payment cycle (payment cycle of the customer). The payment cycle setting is done on the master module.

The System (100) Displays the Only Pending Invoices of the Customers to the User (s) with Respect to Communication:

In preferred embodiment, the system displays the communication history of only the outstanding invoices of the customer. The system does not display the communication history of all the old invoices. Here, the user (s) may view invoice number, amount, call type (this indicates the follow-up call type made to the customer, call date, followed by (name of the person who followed up with the customer), contact person, due date, expected payment date, follow-up date, and remarks.

The System (100) Configured to Alert the User (s) about Communications Based on PDC (Post Dated Cheques) and LC (Letter of Credits) that are Received from the Customers:

In preferred embodiment, the system is configured to alert the user (s) about the invoices against which customers have received PDCs and LCs. The system further alerts the user (s) about the invoices which are kept on hold, for whatever reason, by the customer. Here, the user (s) may revise promised date based on the request of the customer.

Recommendation Module (203) with Respect to Payables Through Communication:

The recommendation module (203) is configured to display and reminds the user (s) about the bill details pertaining to particular vendor. The bill details provides the bill overdue dates such as overdue by 1-30 days after the credit period, 31-60 days overdue, 61-90 days overdue, and also, 91+ days overdue after the credit period. The system (100) further lists the unallocated bills, PDC, LC, and on hold bills that are doubtful to be paid to the selected vendor. Here, the user (s) may also know the total amount to be paid to a particular vendor. In the preferred embodiment, the system further recommends the user (s) about the bills and lists all the individual bills pertaining to the selected vendor. The system (100) recommends the user (s) based on payment terms (terms of payment agreed to with the vendor) and payment cycle of the company.

The System (100) Further Displays the Only Pending Bills of the Vendors to the User (s) with Respect to Communication:

In preferred embodiment, the system (100) displays the communication history of only the outstanding bills of the vendor. This section does not display the history of all the old bills. Here, the user (s) may view invoice number, amount, call type (this indicates the follow-up call type made to the vendor), call date, followed by (name of the person who followed up with the vendor), contact person, due date, expected payment date, follow-up date, and remarks.

The System (100) Configured to Alert the User (s) about Communications Based on PDC (Post Dated Cheques) and LC (Letter of Credits) that are Issued to the Vendors:

In preferred embodiment, the system (100) is configured to alert the user (s) about the bills pertaining to a particular vendor, for which payments are not yet made. Here, the user (s) may revise promised date, if user (s) wants to post pone the payment date after discussing with the vendor.

In another embodiment, the system (100) is further comprises of a master module which is configured to display and store the names of customers and vendors. The displayed list helps the user (s) in accessing individual customer and vendor information such as name, email, contact number, financial status, etc. The system further provides a payment cycle controls the scheduled payments that are eligible for payment in each period. For example, let us assume that a customer has two payment cycles a month, say, 1st and 15th of every month. In such case, all the invoices which are due between 16th and 30th may be paid on 1st of next month and all the invoices which are due between 1st and 15th may be paid on the 16th of the same month. The payment cycle setting is done in the master module. The master module further displays and stores credit insurance limit, LG amount, and LG expiry date in the payment terms section of the customer. Here, the user (s) may upload copies of important customer files in this section.

In the preferred embodiment, the system (100) helps the user (s) to export relevant financial details of the particular customers and vendors to the excel format.

The recommendation module is configured to plot a graph, wherein the graph assists the user (s) in understanding the financial flow details of the customers and vendors in the business with respect to the date and time.

In another embodiment, the system (100) is further configured to set up various configurations such as user roles, user profiles, insurance company policies, form permissions, customer and vendor access permissions, email templates, etc.

In another embodiment, the system (100) further sends email notification to the customers regarding pending invoices, wherein the email notification includes the financial details of the receivables of the company.

In further embodiment, the system (100) is further configured to keep track and update the credit insurance policy purchased by the user (s) for the selected customers, wherein the updated credit insurance policy alerts the user (s) and insurance agency in providing details of invoices which are not paid on due dates of the selected customers

In one embodiment, the system (100) further reminds the user (s) to assist the customers in reminding the customs to renew the expiry of the Letter of Guarantee (LG) provided by the banks on behalf of customers, wherein the letter of guarantee helps the user (s) to provide services to the customers.

In one embodiment, the system (100) further allows the users to manually select the pending invoices and bills of the customers and vendors to send email, wherein the email includes attachment of the financial details of receivables and payables of the company.

In one embodiment of the invention, the system (100) further allows the user to see the net amount receivable or payable from a customer or a vendor, in case the same party is both a customer and a vendor.

In one embodiment of the invention, the system (100) further allows the user to check the credit rating of the customer (s) as per the reputed credit rating agencies.

In one embodiment of the invention, the system (100) further provides access to various users (s) based on the access rights given to them, wherein the users may be given access to information related to few customers and vendors respectively during login.

In one embodiment of the invention, the system (100) further allows users to enter the budgeted or projected sales and purchases of the company for quarterly, monthly, weekly or one-time recurring outflows or overheads of the company. These will be incorporated while generating the projected cash flow statements.

In a further more embodiment of the invention, the system (100) further allows users to generate projected cash flow statements on a daily or weekly or monthly basis. The statement includes a particular bank account, a project, or a division of the company. The system suggests users to borrow funds to fill the gap and recommends the names of financial consultants who may arrange funding, during the shortfall in the projected cash balance.

The invented system eliminates the need to enter complete receivables, payables and cash flows in excel format manually and also eliminates the system which helps the user (s) to manage only financial receivables. The invented system provides a cash flow management application which assists the user (s) in reminding all aspects of financial status which includes receivables management, payables management, overhead expense management, and cash flow projection management. In the invented system, the user (s) may export relevant financial details of the customers and vendors to excel format automatically.

The system is easy to use and simple and is more suitable for applications in trading, services, distribution, manufacturing, real estate, contracting and many other companies.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

I claim:

1. A cash flow management system, the system (100) comprising:
a. at least one computer (101, 102 and 103) and one server 1 (104) at user (s) location for storage of user's business data, wherein the business data includes financial details of the user (s) with respect to their customers and vendors, bank accounts, overhead expenses etc;
b. at least one Desktop Application (DA) at server 1 (104) to fetch the stored financial details from the server 1 (104) and send the data via public or private IP (Internet Protocol) to server 2 (105);
c. at least one processor (105 and 106) at server location for receiving and storing financial details from the server 1 (104) from the user location, wherein the processor (201) further comprises of:
i. a display module (202) configured to display a unified platform to the user (s), wherein the unified platform displays financial status of one or more of customers and vendors with respect to the invoices and bills;
ii. a recommendation module (203) configured to recommend the names of customers and vendors to the user (s) from the displayed list, wherein the recommended names from the displayed list assist the user (s) in reminding pending financial status of the customers and vendors, that needs to be made within the predetermined date and time; and
iii. a cash-flow module (204) configured to provide detailed projected cash flow statement to the user (s), wherein the detailed cash flow statement includes inflows from budgeted sales and purchases, receivables, payables, overhead expenses of the company during a specific period of time;

2. The system as claimed in claim 1, wherein the business data in the server location is automatically updated or synchronized (or manually updated or synchronized) based on the modifications in the server 1 (104) located at the user location by the user (s).

3. The system as claimed in claim 1, wherein the recommendation module (202) further recommends the user (s) about the invoices of the customers and bills of vendors with one or more colors, wherein the indicated colors in the displayed list assist the user (s) in reminding pending financial status of the customers and vendors within the predetermined date.

4. The system as claimed in claim 1, wherein the system (100) further comprises of a recommendation module which is configured to plot a graph, wherein the graph assists the user (s) in understanding the financial flow details in the business with respect to the date and time.

5. The system as claimed in claim 1, wherein the system (100) further comprises of a master module which is configured to display and store the names of customers and vendors, wherein the displayed list helps the user (s) in accessing individual customer and vendor information such as name, email, contact number, financial status, etc.

6. The system as claimed in claim 1, wherein the system is (100) further configured to alert the user (s) about pending financial status of the customers and vendors with respect to the invoices and bills at defined at regular intervals of time even after the predetermined date and time.

7. The system as claimed in claim 1, wherein the system is (100) further configured to set up various configurations such as user roles, user profiles, insurance company policies, form permissions, email templates, etc.

8. The system as claimed in claim 1, wherein the system is (100) further configured to keep track and update the credit insurance policy purchased by the user (s) for the selected customers, wherein the updated credit insurance policy alerts the user (s) and insurance agency in providing details of invoices, which are not paid on due dates of the selected customers

9. The system as claimed in claim 1, wherein the system (100) further reminds the user (s) to assist the customers in reminding the customers to renew the expiry of the letter of guarantee provided by the banks on behalf of customers, wherein the letter of guarantee helps the user (s) to provide services to the customers.

10. The system as claimed in claim 1, wherein the system is (100) further configured to alert the user (s) about the PDC (Post Dated Cheques) and LC (Letter of Credits) that are received and issued from/to the customers and vendors.

11. The system as claimed in claim 1, wherein the system (100) helps the user (s) to export relevant financial details of the particular customers and vendors to excel format.

12. The system as claimed in claim 1, wherein the system (100) further displays the only pending invoices of the customers and bills of the vendors to the user (s), wherein the display of pending invoices and bills includes contact details, mode of payment with respect to predetermined date and time and financial details of the payables and receivables.

13. The system as claimed in claim 12, wherein the system (100) further sends email notification to the customers and vendors regarding pending invoices and bills, wherein the email notification includes the financial details of the receivables and payables of the user (s).

14. The system as claimed in claim 1, wherein the system (100) further suggest users to borrow funds whenever there is shortfall in the projected cash balance and recommends the names of financial consultants who may arrange funding.

15. The system as claimed in claim 1, wherein the system (100) further allows the user to check the credit rating of the customers as per the reputed credit rating agencies.

16. The system as claimed in claim 1, wherein the system (100) further allows users to generate projected cash flow statements on a daily or weekly or monthly basis, wherein the statement includes a particular bank account, a project, or a division of the company.
